(19) United States
(12) Patent Application Publication
(10) Pub. No.: US 2026/0066153 A1
(43) Pub. Date: Mar. 5, 2026

(54) SHIELDED CABLE CHANNEL ELECTROMAGNETIC COMPATIBILITY IMPROVEMENT USING ABSORBERS

(71) Applicant: Infineon Technologies Americas Corp., El Segundo, CA (US)

(72) Inventors: Shaowu HUANG, Los Altos, CA (US); Dance WU, Palo Alto, CA (US)

(73) Assignee: Infineon Technologies Americas Corp., El Segundo, CA (US)

(21) Appl. No.: 19/313,717

(22) Filed: Aug. 28, 2025

Related U.S. Application Data
(60) Provisional application No. 63/691,249, filed on Sep. 5, 2024.
(60) Provisional application No. 63/691,240, filed on Sep. 5, 2024.

(51) Int. Cl. H01B 11/10; H01B 7/17; H01B 11/18

(52) U.S. Cl. CPC H01B 11/1058; H01B 7/17; H01B 11/1895

(57) ABSTRACT

Multi-Gigabit Ethernet communication over shielded cables have challenging electromagnetic compatibility (EMC) and electromagnetic interference (EMI) problems. Circuitry on-board Ethernet physical layer (PHY) transceivers cannot adequately address these problems. In some cases, some circuitry may pose constraints on the transceiver design, making these problems more difficult to address. To improve EMC and increase tolerance to EMI, an improved shielded cable can be used to connect Ethernet PHY transceivers. In particular, a microwave-absorbing material is added to wrap one or more segments of the shielded cable. The microwave-absorbing material can be applied at or near the cable connectors attached to the ends of the shielded cable. One or more parameters of the microwave-absorbing material can be chosen or optimized for a particular type of shielded cable and sensitivity of the Ethernet PHY transceiver to EMC and EMI problems.

### PRIORITY APPLICATION

This patent application claims priority to and/or receives benefit from U.S. Provisional Application No. 63/691,249, titled, “STP Cable Channel EMC Improvement Using Absorbers”, filed on 5 Sep. 2024, and U.S. Provisional Application No. 63/691,240, titled, “Coax Cable Channel EMC Improvement Using Absorbers”, filed on 5 Sep. 2024. The U.S. Provisional Applications are hereby incorporated by reference in their entirety.

### BACKGROUND

Electromagnetic compatibility (EMC) and electromagnetic interference (EMI) and are concerns in high-speed data transmission systems, particularly in automotive and industrial environments where electronic subsystems operate in close proximity. Shielded cable channels, such as coaxial (coax) cables and shielded twisted pair (STP) cables, are commonly used to mitigate EMI and improve EMC by confining electromagnetic fields and reducing radiation and susceptibility. However, even with shielding, shielded cable assemblies can still suffer from EMC/EMI issues due to imperfect shielding, grounding schemes, coupling mechanisms, and lack of effective solutions.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary networked electronics system having a coaxial (coax) cable channel, according to some embodiments of the disclosure.

FIG. 2 illustrates an exemplary networked electronics system having an STP cable channel, according to some embodiments of the disclosure.

FIG. 3 illustrates an exemplary networked electronics system having an exemplary coax cable channel with one or more microwave absorbers, according to some embodiments of the disclosure.

FIG. 4 illustrates an exemplary networked electronics system having an exemplary coax cable channel with one or more microwave absorbers, according to some embodiments of the disclosure.

FIG. 5 illustrates an exemplary networked electronics system having an exemplary coax cable channel with a plurality of microwave absorbers, according to some embodiments of the disclosure.

FIG. 6 illustrates an exemplary networked electronics system having an exemplary STP cable channel with one or more microwave absorbers, according to some embodiments of the disclosure.

FIG. 7 illustrates an exemplary networked electronics system having an exemplary STP cable channel with one or more microwave absorbers, according to some embodiments of the disclosure.

FIG. 8 illustrates an exemplary networked electronics system having an exemplary STP cable channel with a plurality of microwave absorbers, according to some embodiments of the disclosure.

FIG. 9 depicts a flow diagram illustrating methods for manufacturing a coax cable with one or more microwave absorbers, according to some embodiments of the disclosure.

FIG. 10 depicts a flow diagram illustrating methods for manufacturing an STP cable with one or more microwave absorbers, according to some embodiments of the disclosure.

FIG. 11A depicts a sheet of microwave-absorbing material, according to some embodiments of the disclosure.

FIG. 11B depicts a sheet of adhesive material, according to some embodiments of the disclosure.

FIG. 11C depicts a microwave absorber attached to a shielded cable, according to some embodiments of the disclosure.

FIG. 12A depicts a sleeve comprising microwave-absorbing material, according to some embodiments of the disclosure.

FIG. 12B depicts a microwave absorber attached to a shielded cable, according to some embodiments of the disclosure.

### DETAILED DESCRIPTION

### Overview

Multi-Gigabit Ethernet communication over shielded cables have challenging EMC and EMI problems. EMC and EMI problems can cause issues such as radiated emission (RE) problems, radiated immunity (RI) problems, transient problems, bulk current injection (BCI) problems, radar pulse problems, etc. For brevity, the description refers to EMC and EMI collectively as EMC, which encompasses both concerns. EMC problems can degrade and negatively impact signal integrity in communication systems. With Ethernet communications, EMC problems impact integrity of medium-dependent interface (MDI) signals, e.g., MDIP/MDIN, used in Ethernet physical layer (PHY) devices (e.g., Ethernet PHY transceivers) to transmit and receive data in the Ethernet network. MDI is responsible for the physical and electrical connection to the cabling medium, e.g., between the PHY and the cabling mediums.

EMC concerns can be present in various environments and contexts, including automotive, industrial automation, aerospace, avionics, medical devices, data centers, transportation, telecommunications, satellite systems, consumer electronics, smart grids, energy systems, etc.

In one example scenario, multi-Gigabit automotive Ethernet over STP cable channels has unique EMC challenges. Common-mode choke (CMC) circuitry and common-mode termination (CMT) circuitry can be used in Ethernet PHY devices to address EMC concerns, but the circuitries have some shortcomings. Although CMC circuitry is effective for reducing common-mode noises, CMC circuitry can introduce unintentional MDI mode-conversion over a wide band frequency range. The bill of materials (BOM) cost of CMC circuitry can be a concern for some applications. Although CMT circuitry can reduce common-mode MDI noises, CMT distorts differential signals and increases return loss over all frequencies, which can add large reflections and cause failures in physical media attachment compliance tests.

In another example scenario, multi-Gigabit automotive Ethernet over coax cable channels has unique EMC challenges. On-board common-mode filtering circuitry (e.g., CMC circuitry and CMT circuitry) found in Ethernet PHY devices are designed for STP channels and are less or not effective for coax channels. When MDI direct current (DC) grounding connection scheme is used in the Ethernet PHY transceiver, implementing an effective solution to suppress differential-mode noises associated with EMC noises on the coax cable is a challenge. For instance, CMC circuitry is effective for suppressing common-mode noises on coax channels in designs using MDI alternating current (AC) ground connection, but are not effective for differential-mode noises in designs using MDI DC ground connections. Moreover, power over coax (PoC) circuitry presents design constraints on the coax channel EMC design, thereby making the coax channel EMC problems more difficult to handle.

To improve EMC, an improved shielded cable can be used to connect and couple Ethernet PHY transceivers. In particular, one or more absorbers made from microwave-absorbing material, can be added to wrap around one or more segments, portions, or subsections of the shielded cable. The absorber(s) can effectively suppress EMC noise currents on the shielded cable, which can result in better system EMC and avoid any signal integrity (SI) distortions to the MDI signals being carried on the shielded cable. Adding absorbers onto the shielded cable does not impact the on-board circuitry of the Ethernet PHY devices and can improve EMC independent of the type of ground connection schemes. Therefore, the absorbers are effective for cables that connect Ethernet PHY devices with either MDI DC or AC ground connection schemes.

Advantageously, the absorbers can be effective in addressing a variety of EMC performance issues, including RE problems, RI problems, transient problems, BCI problems, radar pulse problems, etc., over a wide frequency range. At the same time, the absorbers do not negatively impact MDI signal integrity because the absorber is added onto and outside the cable jacket and shield, and the absorber is electrically invisible to the MDI signals. The absorbers can be more cost effective than other solutions.

In some embodiments, the absorbers (e.g., microwave-absorbing material) can be applied at or near either one or both cable connectors attached to the two ends of the shielded cable. The cable connector can be a connector that connects the shielded cable to the Ethernet PHY device. The cable connector can be an in-line connector that connects the shielded cable to another shielded cable. The absorbers (e.g., microwave-absorbing material) can be applied at or near one of the cable connectors only, where the cable connector couples the shielded cable to an Ethernet PHY device that is more sensitive to EMC issues than the other Ethernet PHY device.

In some embodiments, the absorbers (e.g., microwave-absorbing material) can be applied at one or more locations along the length of the shielded cable to cover one or more segments, portions, or subsections of the shielded cable.

One or more parameters of the absorber can be chosen or optimized for a particular application, such as a particular type of shielded cable, the environment of the networked electronic system, and potentially different sensitivities of the Ethernet PHY transceivers to EMC problems. Non-trivial and extensive testing and experiments were performed to assess suitable (or optimal) ranges of parameters, such as the length of the absorber, the thickness of the absorber, the location of the absorber (e.g., relative to the cable connector), and the loss tangent of the absorber. Determining the suitable ranges of parameters can inform material selection and absorber design.

The number of absorbers to include for a shielded cable can vary depending on the application. The parameters of the absorbers can be the same for the absorbers provided over the shielded cable, offering a symmetric set of absorbers along the shielded cable. In some cases, the parameters of the absorbers can be different or not necessarily the same for the absorbers provided over the shielded cable, offering an asymmetric set of absorbers along the shielded cable, in the event that the sensitivities of the Ethernet PHY devices to EMC issues are not the same.

While the embodiments described herein relate to coax cables and STP cables, it is envisioned by the disclosure that the embodiments can be applied to a variety of shielded cables, such as foil STP cable, braided shielded cable, armored shielded cable, flexible shielded cable, etc.

Networked Electronics Systems with a Shielded Cable Channel

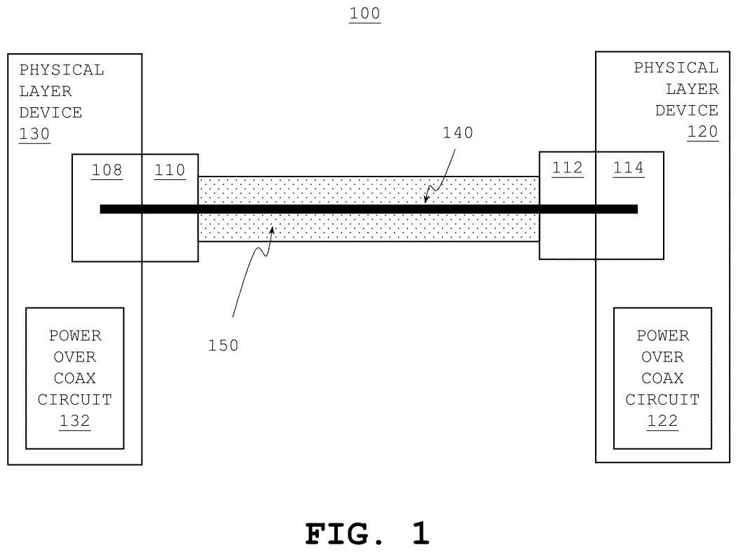

FIG. 1 illustrates exemplary networked electronics system 100 having a coax cable channel, according to some embodiments of the disclosure. Exemplary networked electronics system 100 includes PHY device 130 and PHY device 120. PHY device 130 and PHY device 120 can be Ethernet PHY transceivers. The coax cable channel communicably couples the PHY device 130 and PHY device 120 and allows PHY device 130 and PHY device 120 to communicate with each other. Data can be transmitted over the coax cable channel at high speeds and data rates. PHY device 130 can be coupled to one or more media access controllers (MACs) of electronic devices (not shown). PHY device 120 can be coupled to one or more MACs of electronic devices (not shown).

In some embodiments, PHY device 130 includes PoC circuit 132. In some embodiments, PHY device 120 can include PoC circuit 122. PoC circuit 132 and PoC circuit 122 can include coupling and decoupling networks. At the transmitter side, a PoC circuit can include a bias-T circuitry or equivalent circuitry (e.g., with Bias-T inductors) that superimposes DC power onto the data signal, ensuring minimal interference with high-frequency data transmission. At the receiver side, a PoC circuit can include a corresponding bias-T circuitry or equivalent circuitry (e.g., with Bias-T inductors) to extract the DC power for local use while passing the data signal to the Ethernet PHY device.

PHY device 130 may include MDI 108 that represents a connection or interface between PHY device 130 and the transmission medium, which is the coax cable channel in this illustration. PHY device 120 may include MDI 114 that represents a connection or interface between PHY device 120 and the coax cable channel in this illustration.

The coax cable channel includes a coax cable assembly. The coax cable assembly can include conductor 140 and one or more layers 150 surrounding conductor 140 to form a shielded cable assembly. The coax cable channel further includes cable connector 110 at one end of the coax cable assembly and cable connector 112 at the other end of the coax cable assembly. Cable connector 110 can electromechanically couple an end of the coax cable assembly to a receiving connector (not shown) of PHY device 130 to allow MDI signals to propagate between MDI 108 and the coax cable assembly. Cable connector 112 can electromechanically couple the other end of the coax cable assembly to a receiving connector (not shown) of PHY device 120 to allow MDI signals to propagate between MDI 114 and the coax cable assembly.

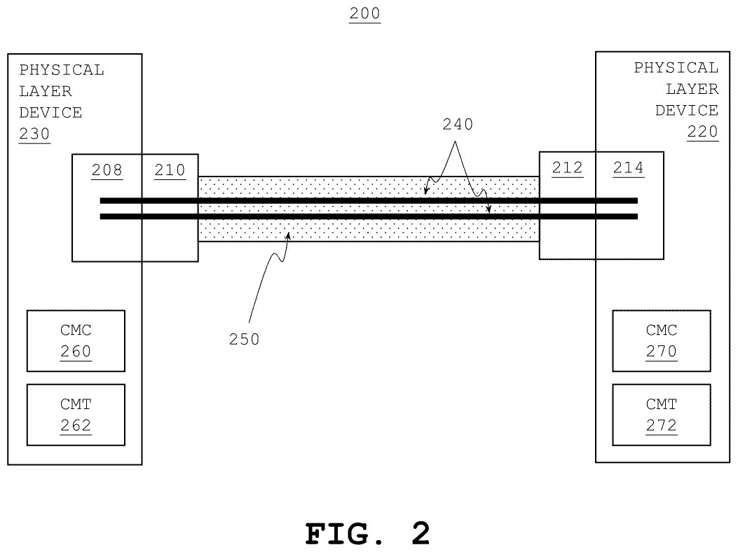

FIG. 2 illustrates exemplary networked electronics system 200 having an STP cable channel, according to some embodiments of the disclosure. Exemplary networked electronics system 200 includes PHY device 230 and PHY device 220. PHY device 230 and PHY device 220 can be Ethernet PHY transceivers. The STP cable channel communicably couples the PHY device 230 and PHY device 220 and allows PHY device 230 and PHY device 220 to communicate with each other. Data can be transmitted over the STP cable channel at high speeds and data rates. PHY device 230 can be coupled to one or more MACs of electronic devices (not shown). PHY device 220 can be coupled to one or more MACs of electronic devices (not shown).

In some embodiments, PHY device 230 includes one or more of CMC circuit 260 and CMT circuit 262. In some embodiments, PHY device 220 can include one or more of CMC circuit 270 and CMT circuit 272. CMC circuit 260 and CMC circuit 270 may include a magnetic core with multiple windings to suppress common-mode noise while allowing differential signals to pass with minimal attenuation. CMT circuit 262 and CMT circuit 272 can include a resistive-capacitive (RC) network coupled between the differential signal lines and a reference potential to form a center-tapped RC termination that presents a low-impedance path to common-mode signals while minimally affecting differential-mode signals. The resistors help match the impedance of the transmission line and absorb common-mode currents, while the capacitor provides a low-impedance path to ground for high-frequency common-mode noise.

PHY device 230 may include MDI 208 that represents a connection or interface between PHY device 230 and the transmission medium, which is the STP cable channel in this illustration. PHY device 220 may include MDI 214 that represents a connection or interface between PHY device 220 and the STP cable channel in this illustration.

The STP cable channel includes an STP cable assembly. The STP cable assembly can include conductors 240 and one or more layers 250 surrounding conductors 240 to form a shielded cable assembly. The STP cable channel further includes cable connector 210 at one end of the STP cable assembly and cable connector 212 at the other end of the STP cable assembly. Cable connector 210 can electromechanically couple an end of the STP cable assembly to a receiving connector (not shown) of PHY device 230 to allow MDI signals to propagate between MDI 108 and the STP cable assembly. Cable connector 212 can electromechanically couple the other end of the STP cable assembly to a receiving connector (not shown) of PHY device 220 to allow MDI signals to propagate between MDI 214 and the STP cable assembly.

### Adding One or More Absorbers to Shielded Cable Channel

The embodiments herein can be applied to shield cable assemblies and shielded cables, such as coax cable and STP cable. A shielded cable assembly can include one or more insulated conductors. A coax cable can have a single insulated conductor. An STP cable can have one or more twisted pairs of insulated conductors to carry differential signals. A category 5 STP cable can have four twisted pairs of insulated conductors. The conductor can be made from copper or other conductive materials including gold, silver, aluminum, tinned copper, copper-clad aluminum, etc. The insulation around the conductor can be made from a dielectric material, such as solid or foamed polyethylene, polyvinyl chloride, fluorinated ethylene propylene, polytetrafluoroethylene, polypropylene, thermoplastic elastomer, etc.

The shielded cable assembly can further include a shield or shielding material surrounding the one or more insulated conductors. In some cases, the shielding material may have voids or imperfections. The one or more insulated conductors may be individual shielded or shielded all together as a bundle of insulated conductors. The shielding material may include a thin aluminum or copper foil that is helically wrapped around the one or more insulated conductors to form a shielding layer. The shielding material may have a mesh of copper or aluminum strands that are braided to form a shielding layer around the one or more insulated conductors. The shielding material may include one or more foil layers and one or more braided layers.

The shielded cable assembly can include a cable jacket or a cable jacket layer surrounding the shielding material to protect the inner components of the shielded cable assembly. The cable jacket can be smooth or ribbed. The cable jacket layer can be made from polyvinyl chloride, polyethylene, low smoke zero halogen, polyurethane, thermoplastic elastomer, fluorinated ethylene propylene, rubber, neoprene, nylon, polyamide.

The shielded cable assembly can include a first end and a second end. The first end and the second end can be stripped ends of the shielded cable assembly where the conductor is exposed. The shielded cable assembly can include one or more of a first cable connector and a second cable connector (e.g., cable connector 110 and cable connector 112 of FIGS. 1 and 3-5, and cable connector 210 and cable connector 212 of FIGS. 2 and 6-8). Cable connectors are mechanical and electrical interfaces used to terminate cables and enable connection to devices, other cables, or ports. The first end can be coupled to the first cable connector, where the first cable connector can be attached or affixed (e.g., via crimping, soldering, compression, etc.) onto the first end. The first cable connector can be coupled to PHY device 120. The second end can be coupled to the second cable connector, where the second cable connector can be attached or affixed (e.g., via crimping, soldering, compression, etc.) onto the second end. The second cable connector can be coupled to PHY device 130.

Referring briefly to FIG. 1, one or more layers 150 can include one or more of: insulation around the conductor, shielding around the insulated conductor, optional filler material, and cable jacket. Referring briefly to FIG. 2, one or more layers 250 can include one or more of: insulation around the conductor, shielding around the insulated conductor, optional filler material, and cable jacket.

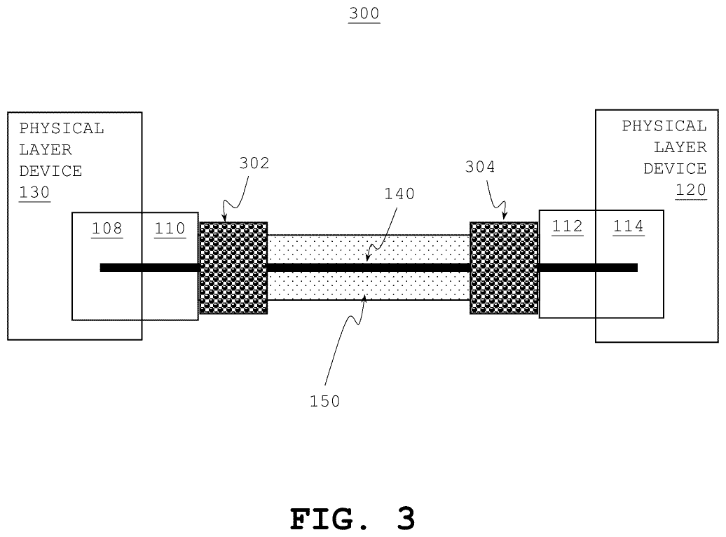

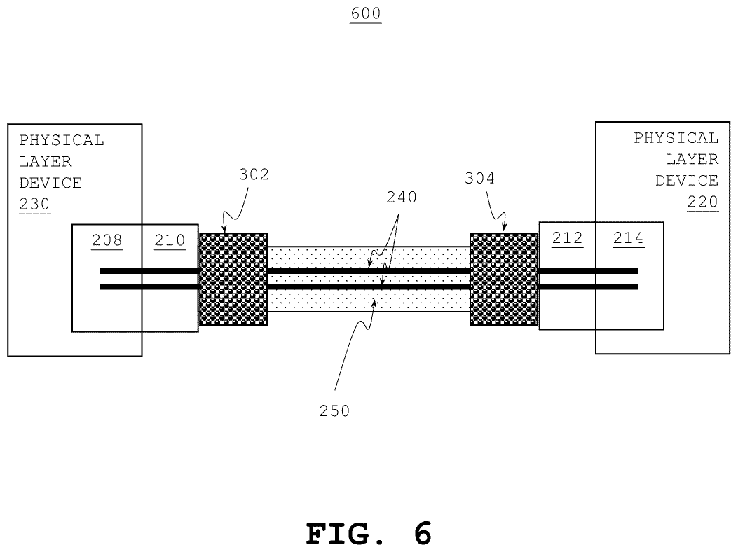

FIGS. 3-5 illustrate one or more absorbers (e.g., microwave-absorbing material) disposed around the cable jacket layer of a coax cable. FIGS. 6-8 one or more absorbers (e.g., microwave-absorbing material) disposed around the cable jacket layer of a coax cable. Microwave-absorbing material can cover and surround one or more segments of the cable jacket layer. The microwave-absorbing material can form a microwave-absorbing sleeve surrounding and covering a portion of the cable jacket. Parameters of the microwave-absorbing material applied to the shielded cable assembly can vary depending on the application.

FIG. 3 illustrates exemplary networked electronics system 300 having an exemplary coax cable channel with one or more microwave absorbers, according to some embodiments of the disclosure. One or more absorbers, e.g., absorber 302 and/or absorber 304, can cover respective segments of the cable jacket layer. As depicted, absorber 302 is placed at the first end of the cable, and absorber 304 is placed at the second end of the cable. The segment of the cable jacket layer covered by absorber 302 is adjacent to and can abut cable connector 110. The segment of the cable jacket layer covered by absorber 304 is adjacent to and can abut cable connector 112.

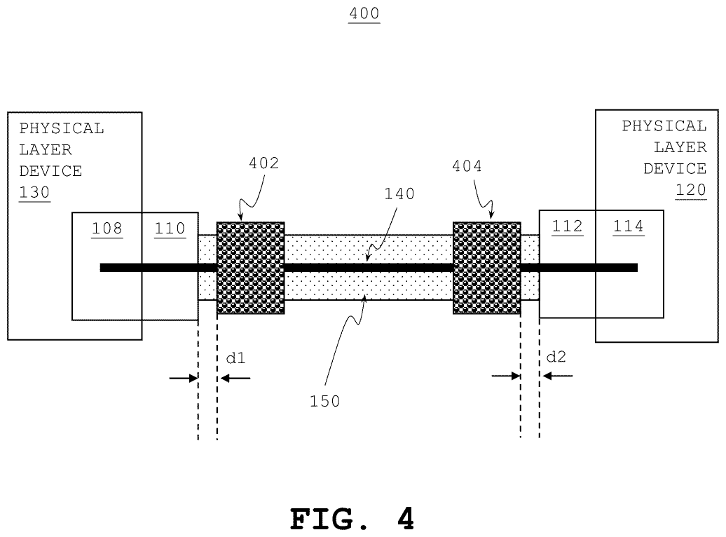

FIG. 4 illustrates exemplary networked electronics system 400 having an exemplary coax cable channel with one or more microwave absorbers, according to some embodiments of the disclosure. One or more absorbers, e.g., absorber 402 and/or absorber 404, can cover respective segments of the cable jacket layer. As depicted, absorber 402 is placed near, close to, or towards the first end of the cable or cable connector 110, and absorber 404 is placed near, close to, or towards the second end of the cable or cable connector 112. Absorber 402 can be located or disposed at a location that is closer to the first end of the cable or cable connector 110 than a mid-length point, halfway point, or middle point of the shielded cable assembly. Absorber 404 can be located or disposed at a location that is closer to the second end of the cable or cable connector 112 than a mid-length point, halfway point, or middle point of the shielded cable assembly.

The segment of the cable jacket layer covered by absorber 402 is at a distance d1 from (an edge of) cable connector 110. The segment of the cable jacket layer covered by absorber 304 is at a distance d2 from (an edge of) cable connector 112. In some embodiments, the distance d1 and the distance d2 are the same. In some embodiments, the distance d1 and the distance d2 are not the same. The gap offered by placing an absorber at a small distance from the cable connector can be beneficial in scenarios where the physical environment near PHY device 130 and/or PHY device 120 (e.g., enclosures, possibility of thermal expansion of materials, physical tolerances, etc.) may demand cable ends to be small or does not offer a lot of room to accommodate added microwave-absorbing material at the cable ends. Phrased differently, placing an absorber close to but not at the cable connector is useful when space near the physical connection of the shielded cable to PHY device 120 and/or PHY device 130 is limited—due to enclosures, thermal expansion, or tight tolerances—and cannot accommodate extra microwave-absorbing material at the cable ends.

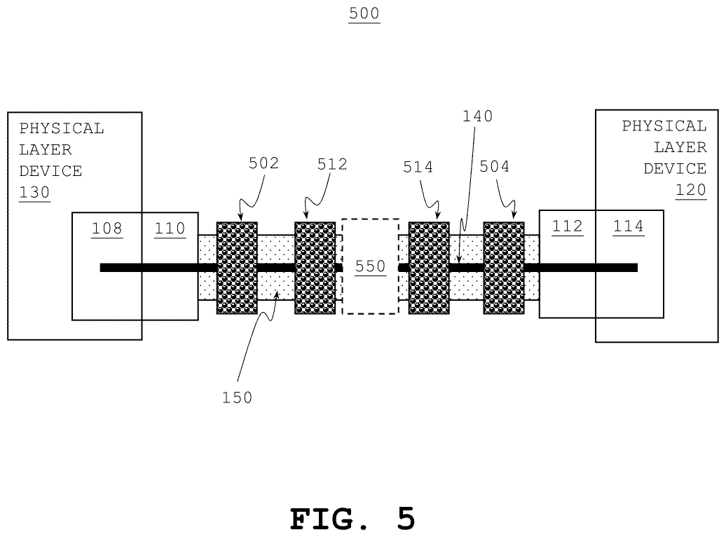

FIG. 5 illustrates exemplary networked electronics system 500 having an exemplary coax cable channel with a plurality of microwave absorbers, according to some embodiments of the disclosure. Plurality of absorbers, e.g., absorber 502, absorber 512, absorber 514, and absorber 504, can cover respective segments of the cable jacket layer. Locations of the absorbers can be distributed (evenly or substantially evenly) over the length of the shielded cable assembly. Locations of the absorbers can be distributed in a manner that places the absorbers closer towards the ends of the shielded cable assembly. Locations of the absorbers can be distributed in a manner that places the absorbers closer towards the cable connectors in the coax cable channel. Having more absorbers can better improve EMC.

Absorber 502 can be placed at, adjacent to, near, close to, or towards the first end of the cable or cable connector 110. Absorber 504 can be placed at, adjacent to, near, close to, or towards the second end of the cable or cable connector 112. Absorber 502 can be located or disposed at a location that is closer to the first end of the cable or cable connector 110 than a mid-length point, halfway point, or middle point of the shielded cable assembly. Absorber 504 can be located or disposed at a location that is closer to the second end of the cable or cable connector 112 than a mid-length point, halfway point, or middle point of the shielded cable assembly.

In some embodiments, absorber 512 and/or absorber 514 may be disposed around one or more segments along the length of the coax cable assembly at one or more suitable locations of the coax cable assembly.

In some embodiments, the coax cable channel may include in-line connector 550 that connects/couples two or more coax cables together. Absorber 512 and/or absorber 514 may be placed at, adjacent to, near, close to, or towards in-line connector 550 (e.g., on either ends of in-line connector 550).

FIG. 6 illustrates exemplary networked electronics system 600 having an exemplary STP cable channel with one or more microwave absorbers, according to some embodiments of the disclosure. Absorber 302 and/or 304 illustrated in FIG. 3 can be applied in the same manner to the STP cable assembly in FIG. 6.

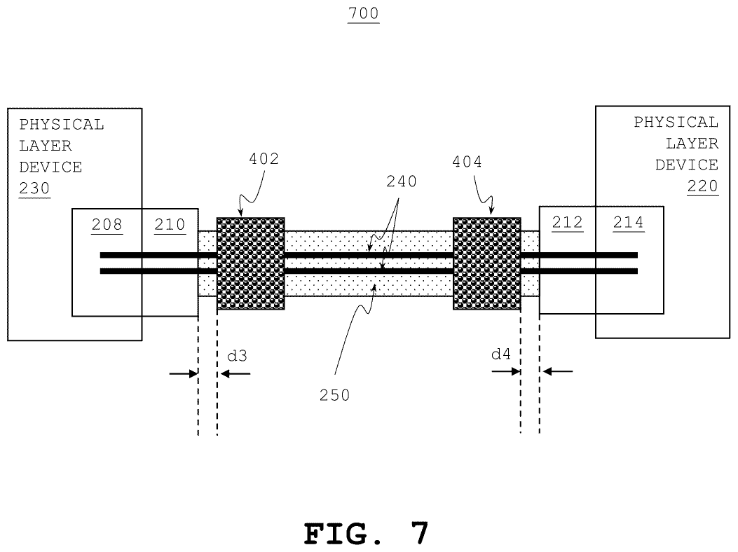

FIG. 7 illustrates exemplary networked electronics system 700 having an exemplary STP cable channel with one or more microwave absorbers, according to some embodiments of the disclosure. Absorber 402 and/or 404 illustrated in FIG. 4 can be applied in the same manner to the STP cable assembly in FIG. 7. Exemplary networked electronics system 600 can be different from exemplary networked electronics system 400, the distances d3 and d4 of FIG. 7 may be chosen differently than the distances d1 and d2 of FIG. 4.

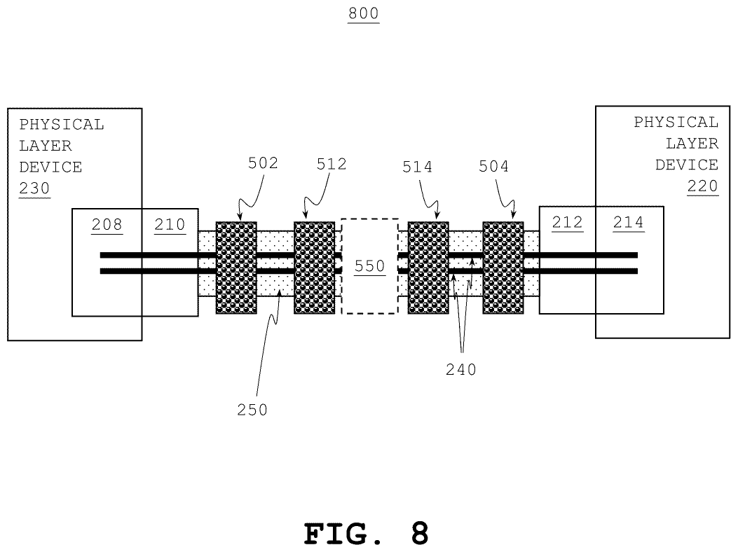

FIG. 8 illustrates exemplary networked electronics system 800 having an exemplary STP cable channel with a plurality of microwave absorbers, according to some embodiments of the disclosure. One or more of absorber 504, absorber 512, absorber 514, and absorber 504 illustrated in FIG. 5 can be applied in the same manner to the STP cable assembly in FIG. 8.

### Selecting or Determining One or More Parameters for the Microwave-Absorbing Material or Sleeve

The absorber can be tuned or optimized. Parameters for the absorber can be carefully selected or determined for a particular application. Parameters can include the type of material, location of placement of the absorber on the shielded cable assembly, distance to a cable end or cable connector, the length of the absorber, the thickness of the absorber, the loss tangent of the absorber, the dielectric constant of the absorber, etc. Non-trivial testing and validations have been carried out with experimental setups to test, validate, and confirm the effectiveness of the absorbers to improve EMC. Moreover, suitable ranges of parameters that offer significant (and maximum) improvement to EMC have been determined from the results of the testing and validations.

The absorber can be made from microwave-absorbing materials, such as materials impregnated with carbon particles and/or magnetic particles. One example includes Cumming Microwave C-RAM MT, which is a carbon loading broadband microwave foam material with a suitable service temperature range and is fire retardant grade. Another example includes ZIPSIL 601 RAM, which is a magnetic nano/micro broadband microwave foam material with a suitable service temperature range and is fire retardant grade. Further examples include Laird Eccosorb GDS, BSR, MFS, and Parker CHO-MUTE 9005, which are carbon or magnetic particles loading broadband microwave foam material with a suitable service temperature range.

In one experiment, EMC improvement is evaluated for a coax cable with absorbers having different lengths. The result reveals that a longer absorber can lead to larger EMC improvement. A length of 10 centimeters can be good enough for effectively suppressing EMC/EMI noises. In another experiment, EMC improvement is evaluated for an STP cable with absorbers having different lengths. The result reveals that a longer absorber can lead to larger EMC improvement. The length of the absorber can have a proportional (e.g., a linear) relationship with the achievable amount of noise suppression (e.g., in decibels or dBs). A length of 10 centimeters can be good enough for effectively suppressing EMC/EMI noises. A good enough length can be determined based on the dB noise attenuation to be achieved for a given application. In some embodiments, the length of the microwave-absorbing material (e.g., absorber sleeve) covering a segment of the cable jacket layer is between 5 centimeters and 10 centimeters. In some embodiments, the length of the microwave-absorbing material (e.g., absorber sleeve) covering a segment of the cable jacket layer is substantially 10 centimeters.

In one experiment, EMC improvement is evaluated for a coax cable with absorbers having varying distances from the cable end or a cable connector. The result reveals that EMC improvement is insensitive to distance, or that some distance can be tolerated. A distance of 15 centimeters can be sufficiently effective in suppressing EMC/EMI noises. In some embodiments, the segment of the cable jacket layer covered by the microwave-absorbing material (e.g., the absorber sleeve) and the cable connector are separated by a distance that is equal to or less than 15 centimeters. In some embodiments, the segment of the cable jacket layer covered by the microwave-absorbing material (e.g., the absorber sleeve) and the cable connector are separated by a distance that is between 10 and 15 centimeters. In some embodiments, the segment of the cable jacket layer covered by the microwave-absorbing material (e.g., the absorber sleeve) and the cable connector are separated by a distance that is between 5 and 15 centimeters. In some embodiments, the segment of the cable jacket layer covered by the microwave-absorbing material (e.g., the absorber sleeve) and the cable connector are separated by a distance that is between 1 and 15 centimeters. In another experiment, EMC improvement is evaluated for an STP cable with absorbers having varying distances from the cable end or a cable connector. The result reveals that EMC improvement is insensitive to distance, or that some distance can be tolerated. A distance of 5 centimeters can be sufficiently effective in suppressing EMC/EMI noises. In some embodiments, the segment of the cable jacket layer covered by the microwave-absorbing material (e.g., the absorber sleeve) and the cable connector are separated by a distance that is equal to or less than 5 centimeters. In some embodiments, the segment of the cable jacket layer covered by the microwave-absorbing material (e.g., the absorber sleeve) and the cable connector are separated by a distance that is between 3 and 5 centimeters. In some embodiments, the segment of the cable jacket layer covered by the microwave-absorbing material (e.g., the absorber sleeve) and the cable connector are separated by a distance that is between 1 and 5 centimeters.

In one experiment, EMC improvement is evaluated for a coax cable with absorbers having different loss tangents. The result reveals that a higher loss tangent can lead to larger EMC improvement. A loss tangent of 0.5 can be good enough for effectively suppressing EMC/EMI noises. In another experiment, EMC improvement is evaluated for an STP cable with absorbers having different loss tangents. The result reveals that a longer absorber can lead to larger EMC improvement. The result reveals that a higher loss tangent can lead to larger EMC improvement. A loss tangent of 1.5 can be good enough for effectively suppressing EMC/EMI noises. In some embodiments, the loss tangent of the microwave-absorbing material (e.g., absorber sleeve) covering a segment of the cable jacket layer is equal to or less than 1.5. In some embodiments, the loss tangent of the microwave-absorbing material (e.g., absorber sleeve) covering a segment of the cable jacket layer is substantially 1.5. In some embodiments, the loss tangent of the microwave-absorbing material (e.g., absorber sleeve) covering a segment of the cable jacket layer is equal to or less than 1.0. In some embodiments, the loss tangent of the microwave-absorbing material (e.g., absorber sleeve) covering a segment of the cable jacket layer is substantially 1.0. In some embodiments, the loss tangent of the microwave-absorbing material (e.g., absorber sleeve) covering a segment of the cable jacket layer is equal to or less than 0.5. In some embodiments, the loss tangent of the microwave-absorbing material (e.g., absorber sleeve) covering a segment of the cable jacket layer is substantially 0.5.

Methods of Manufacture or Assembly of Shielded Cables with Improved EMC

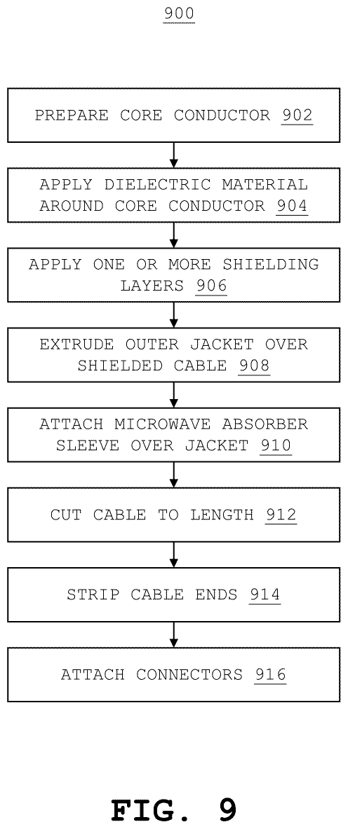

FIG. 9 depicts a flow diagram illustrating methods for manufacturing a coax cable with one or more microwave absorbers, according to some embodiments of the disclosure.

In 902 of method 900, a core conductor may be prepared. For example, a selected conductor material can be drawn through a series of dies to achieve a desired diameter and can be subsequently annealed.

In 904 of method 900, dielectric material can be applied around the core conductor to form an insulated conductor. For example, a dielectric insulating layer can be extruded concentrically around the core conductor with uniform thickness and concentricity.

In 906 of method 900, one or more shielding layers can be applied. For example, a metallized foil (e.g., made with aluminum) can be helically wrapped around the insulated conductor to provide some EMI protection. A metallic braid (e.g., made with copper or aluminum strands) can be applied over the foil layer using a braiding machine for added strength and EMI shielding.

In 908 of method 900, an outer jacket can be extruded over the shielded cable. For example, an outer protective cable jacket can be formed from materials with good environmental properties and flexibility. Extrusion can ensure that the cable jacket is smooth and continuous.

Operations 902, 904, 906 and 908 can form a shielded cable (e.g., a coax cable), where the shielded cable can include one or more insulated conductors, a shield, and a cable jacket.

In 910 of method 900, an absorber, e.g., microwave absorber sleeve can be attached over the jacket. For example, microwave-absorbing material can be applied to an outer surface of the shielded cable (e.g., outside of or over the cable jacket). Microwave-absorbing material can be applied in manners illustrated in FIGS. 3-5. The microwave-absorbing material can be applied to an outer surface of the shielded cable, e.g., concentrically or wrapping around, to cover or surround a subsection of the outer surface of the shield cable.

In 912 of method 900, the cable can be cut to length. For example, the shielded cable assembly can be cut to predetermined lengths using mechanical cutting equipment. The cut cable assembly can be coiled or put on a spool if applicable.

In 914 of method 900, the cable ends can be stripped. For example, the ends of the shielded cable assembly can be stripped using mechanical stripping equipment to expose the conductor.

In 916 of method 900, cable connectors can be attached to the stripped cable ends. For example, connectors can be affixed to the stripped end of a cut shielded cable through crimping, compression, and/or soldering.

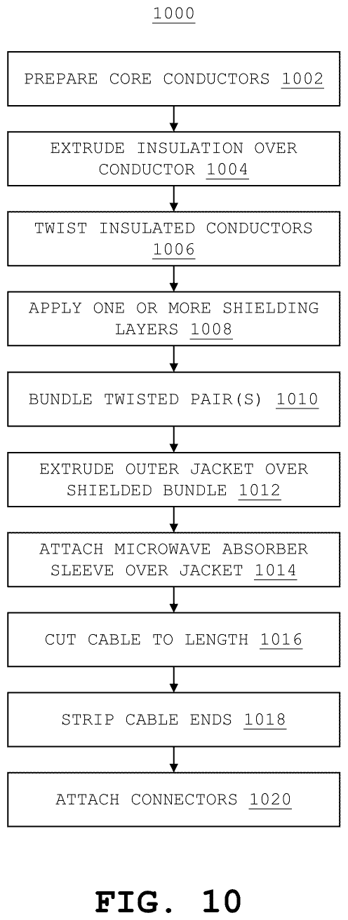

FIG. 10 depicts a flow diagram illustrating methods for manufacturing an STP cable with one or more microwave absorbers, according to some embodiments of the disclosure.

In 1002 of method 1000, a plurality of core conductor may be prepared. For example, a selected conductor material can be drawn through a series of dies to achieve a desired diameter and can be subsequently annealed.

In 1004 of method 1000, dielectric material can be applied around a core conductor to form an insulated conductor. For example, a dielectric insulating layer can be extruded concentrically around the core conductor with uniform thickness and concentricity.

In 1006 of method 1000, two insulated conductors can be twisted to form a twisted pair. For example, two insulated copper conductor can be twisted together to form a pair. The twist rate (e.g., twists per inch) can be controlled to reduce EMI and crosstalk.

In 1008 of method 1000, one or more shielding layers can be optionally applied to a twisted pair of insulated conductors. For example, a metallized foil (e.g., made with aluminum) can be helically wrapped around a twisted pair of insulated conductors to provide some EMI protection. A metallic braid (e.g., made with copper or aluminum strands) can be applied over the foil layer using a braiding machine for added strength and EMI shielding. In some cases, one or more shielding layers are applied per twisted pair of insulated conductors.

In 1010 of method 1000, one or more twisted pairs can be bundled. If the shielded cable is a multi-pair STP cable, a plurality of twisted pairs can be bunded.

Optionally, one or more shielding layers can be optionally applied to a bundle of twisted pairs (which may be unshielded twisted pairs or shielded twisted pairs). For example, a metallized foil (e.g., made with aluminum) can be helically wrapped around the bundle of twisted pairs to provide some EMI protection. A metallic braid (e.g., made with copper or aluminum strands) can be applied over the foil layer using a braiding machine for added strength and EMI shielding.

In 1012 of method 1000, an outer jacket can be extruded over the shielded bundle. For example, an outer protective cable jacket can be formed from materials with good environmental properties and flexibility. Extrusion can ensure that the cable jacket is smooth and continuous.

Operations 1002, 1004, 1008, 1010, and 1012 can form a shielded cable (e.g., a STP cable), where the shielded cable can include a plurality of insulated conductors, a shield, and a cable jacket.

In 1014 of method 1000, an absorber, e.g., microwave absorber sleeve can be attached over the jacket. For example, microwave-absorbing material can be applied to an outer surface of the shielded cable (e.g., outside of or over the cable jacket). Microwave-absorbing material can be applied in manners illustrated in FIGS. 5-8. The microwave-absorbing material can be applied to an outer surface of the shielded cable, e.g., concentrically or wrapping around, to cover or surround a subsection of the outer surface of the shield cable.

In 1016 of method 1000, the cable can be cut to length. For example, the shielded cable assembly can be cut to predetermined lengths using mechanical cutting equipment. The cut cable assembly can be coiled or put on a spool if applicable.

In 1018 of method 1000, the cable ends can be stripped. For example, the ends of the shielded cable assembly can be stripped using mechanical stripping equipment to expose the conductors.

In 1020 of method 1000, cable connectors can be attached to the stripped cable ends. For example, connectors can be affixed to the stripped end of a cut shielded cable through crimping, compression, and/or soldering.

### Exemplary Microwave-Absorbing Materials Applicable to Shielded Cables

The absorber can be attached to the shielded cable via an adhesive and/or surface friction.

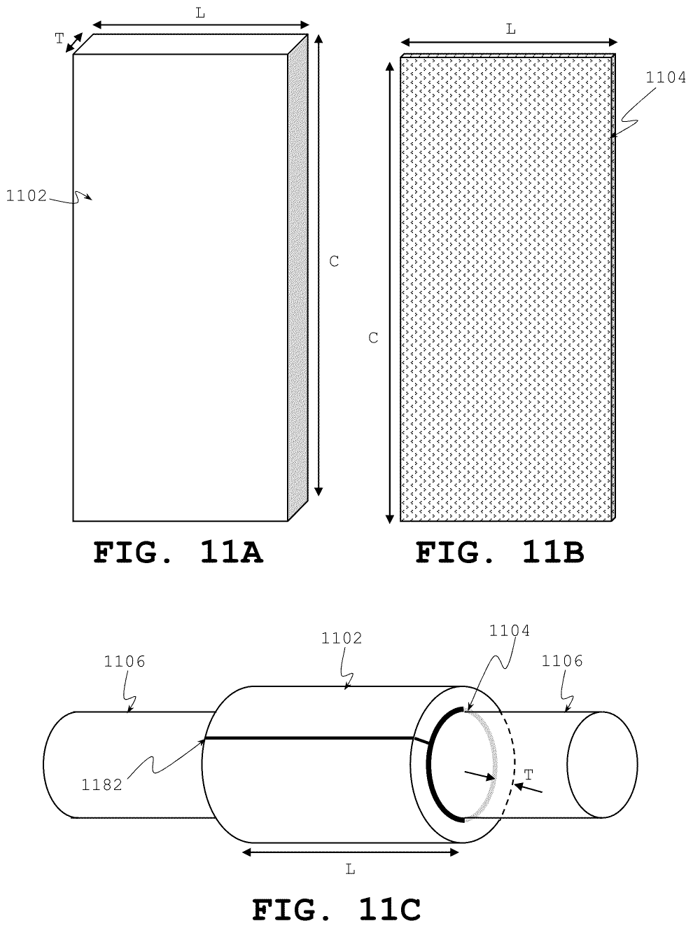

FIG. 11A depicts sheet 1102 of microwave-absorbing material, according to some embodiments of the disclosure. FIG. 11B depicts sheet 1104 of adhesive material, according to some embodiments of the disclosure. FIG. 11C depicts a microwave absorber attached to a shielded cable 1106, according to some embodiments of the disclosure.

Sheet 1102 can be a rectangular sheet. The rectangular sheet can be formed by cutting a larger sheet of microwave-absorbing material or by cutting a strip of microwave-absorbing material from a roll of microwave-absorbing material. Sheet 1102 can have a dimension, e.g., C, that substantially corresponds to an outer circumference of shielded cable 1106 of FIG. 11C. Sheet 1102 can have a further dimension, e.g., L, that corresponds to a length of the absorber. The length can be between 5 centimeters to 10 centimeters, substantially 10 centimeters, substantially 5 centimeters, etc. Sheet 1102 can have a further dimension, e.g., T, that corresponds to a thickness of the absorber. The thickness can be equal to or less than 1 centimeter, substantially 1 centimeter, etc.

Sheet 1104 can be a rectangular sheet. The rectangular sheet can be formed by cutting a larger sheet of adhesive material (e.g., double sided adhesive tape) or by cutting a strip of adhesive material from a roll of adhesive material. Sheet 1104 can have a dimension, e.g., C, that substantially corresponds to an outer circumference of shielded cable 1106 of FIG. 11C. In some cases, the dimension, e.g., C, can be greater than the outer circumference of shielded cable 1106 of FIG. 11C Sheet 1104 can have a further dimension, e.g., L, that corresponds to a length of the absorber. In some cases, the dimension L, can be greater than the length of the absorber. In some cases, the dimension L can be smaller than the length of the absorber. The length can be between 5 centimeters to 10 centimeters, substantially 10 centimeters, substantially 5 centimeters, etc.

In some embodiments, if an adhesive is used, sheet 1104 can be wrapped around shielded cable 1106 to cover a segment of shielded cable 1106. In some embodiments, sheet 1104 can be applied to a surface of sheet 1102. In some embodiments, adhesive material (e.g., glue) can be applied to the segment of shielded cable 1106. In some embodiments, adhesive material (e.g., glue) can be applied to a surface of sheet 1102. In some embodiments, adhesive material (e.g., glue) can be applied to both the segment of shielded cable 1106 and a surface of sheet 1102.

In some embodiments, the manufacturing process of shielded cable 1106 with one or more absorbers can include applying an adhesive to the subsection of the outer surface of shielded cable 1106 and/or a surface of the microwave-absorbing material prior to applying the microwave-absorbing material onto the subsection of the outer surface of shielded cable 1106.

In some embodiments, after the adhesive is applied (if used), sheet 1102 can be wrapped around the segment of shielded cable 1106 to form a tubular sleeve around the segment of shielded cable 1106, covering the segment. The sleeve may have seam 1182 where two edges of sheet 1102 can meet or join.

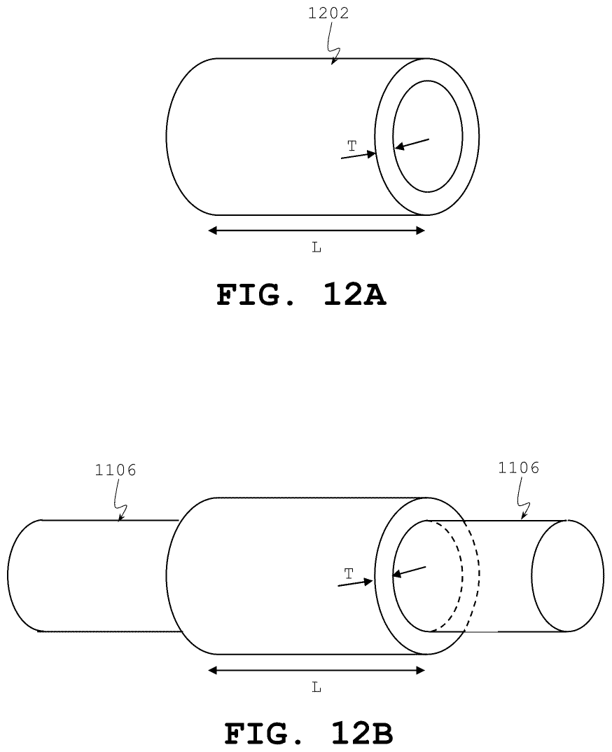

FIG. 12A depicts sleeve 1202 comprising microwave-absorbing material, according to some embodiments of the disclosure. FIG. 12B depicts a microwave absorber attached to shielded cable 1106, according to some embodiments of the disclosure.

Sleeve 1202 can be formed as a tubular sleeve from microwave-absorbing material. In some embodiments, microwave-absorbing material can be extruded or formed into a tubular shape and cut to length, e.g., L. Sleeve 1202 can have a length, e.g., L, that corresponds to a length of the absorber. The length can be between 5 centimeters to 10 centimeters, substantially 10 centimeters, substantially 5 centimeters, etc. Sleeve 1202 can have a further dimension, e.g., T, that corresponds to a thickness of the absorber. The thickness can be equal to or less than 1 centimeter, substantially 1 centimeter, etc.

In some embodiments, adhesive material (e.g., glue) can be applied to the segment of shielded cable 1106. In some embodiments, adhesive material (e.g., glue) can be applied to an inner surface of sleeve 1202. In some embodiments, adhesive material (e.g., glue) can be applied to both the segment of shielded cable 1106 and an inner surface of sleeve 1202. In some embodiments, the adhesive is optional or omitted.

In some embodiments, the manufacturing process of shielded cable 1106 with one or more absorbers can include sliding sleeve 1202 onto the subsection of the outer surface of shielded cable 1106.

### SELECT EXAMPLES

Example 1 provides a shielded cable assembly with improved electromagnetic compatibility, the shielded cable assembly including one or more insulated conductors; shielding material surrounding the one or more insulated conductors; a cable jacket layer surrounding the shielding material; a first end coupled to a first cable connector; a second end coupled to a second cable connector; and a first microwave-absorbing material disposed around the cable jacket layer, where the first microwave-absorbing material covers a first segment of the cable jacket layer.

Example 2 provides the shielded cable assembly of example 1, where the first segment of the cable jacket layer covered by the first microwave-absorbing material is adjacent to the first cable connector.

Example 3 provides the shielded cable assembly of example 1 or 2, where the first segment of the cable jacket layer covered by the first microwave-absorbing material is disposed at a distance from the first cable connector.

Example 4 provides the shielded cable assembly of any one of examples 1-3, where the first segment of the cable jacket layer covered by the first microwave-absorbing material is disposed at a location that is closer to the first end than a mid-length point of the shielded cable assembly.

Example 5 provides the shielded cable assembly of any one of examples 1-4, where the first segment of the cable jacket layer covered by the first microwave-absorbing material and the first cable connector are separated by a distance that is equal to or less than 15 centimeters from the first cable connector.

Example 6 provides the shielded cable assembly of any one of examples 1-5, where the first segment of the cable jacket layer covered by the first microwave-absorbing material and the first cable connector are separated by a distance that is equal to or less than 5 centimeters.

Example 7 provides the shielded cable assembly of any one of examples 1-6, where a length of the first microwave-absorbing material covering the first segment of the cable jacket layer is between 5 centimeters and 10 centimeters.

Example 8 provides the shielded cable assembly of any one of examples 1-7, where a thickness of the first microwave-absorbing material covering the first segment of the cable jacket layer is equal to or less than 1 centimeter.

Example 9 provides the shielded cable assembly of any one of examples 1-8, where a loss tangent of the first microwave-absorbing material is equal to or less than 1.5.

Example 10 provides the shielded cable assembly of any one of examples 1-9, where a loss tangent of the first microwave-absorbing material is equal to or less than 0.5.

Example 11 provides the shielded cable assembly of any one of examples 1-10, where the first microwave-absorbing material includes one or more of: carbon particles and magnetic particles.

Example 12 provides the shielded cable assembly of any one of examples 1-11, where the first cable connector is an in-line cable connector.

Example 13 provides the shielded cable assembly of any one of examples 1-12, further including a second microwave-absorbing material disposed around the cable jacket layer and covers a second segment of the cable jacket layer.

Example 14 provides the shielded cable assembly of any one of examples 1-13, further including a third microwave-absorbing material disposed around the cable jacket layer and covers a third segment of the cable jacket layer.

Example 15 provides the shielded cable assembly of any one of examples 1-14, where the shielded cable assembly is a coaxial cable.

Example 16 provides the shielded cable assembly of any one of examples 1-14, where the shielded cable assembly is a shielded twisted pair cable.

Example 17 provides the shielded cable assembly of any one of examples 1-15, further including an adhesive layer between the first microwave-absorbing material and the cable jacket layer.

Example 18 provides a networked electronics system with improved electromagnetic compatibility, the networked electronics system including a first Ethernet physical layer transceiver; a second Ethernet physical layer transceiver; and a shielded cable to communicably couple the first Ethernet physical layer transceiver and the second Ethernet physical layer transceiver, the shielded cable including one or more insulated conductors; a shield surrounding the one or more insulated conductors; a cable jacket surrounding the shield; a first cable connector attached to a first terminating end of the shielded cable and coupled to the first Ethernet physical layer transceiver; a second cable connector attached to a second terminating end of the shielded cable and coupled to the second Ethernet physical layer transceiver; and a microwave-absorbing sleeve surrounding and covering a portion of the cable jacket.

Example 19 provides the networked electronics system of example 18, where the portion of the cable jacket covered by the microwave-absorbing sleeve is adjacent to the first cable connector.

Example 20 provides the networked electronics system of example 18 or 19, where the portion of the cable jacket covered by the microwave-absorbing sleeve is disposed at a distance from the first cable connector.

Example 21 provides the networked electronics system of any one of examples 18-20, where the portion of the cable jacket covered by the microwave-absorbing sleeve is disposed at a location that is closer to the first terminating end than a mid-length point of the shielded cable.

Example 22 provides the networked electronics system of any one of examples 18-21, where the portion of the cable jacket covered by the microwave-absorbing sleeve and the first cable connector are separated by a distance that is equal to or less than 15 centimeters from the first cable connector.

Example 23 provides the networked electronics system of any one of examples 18-22, where the portion of the cable jacket covered by the microwave-absorbing sleeve and the first cable connector are separated by a distance that is equal to or less than 5 centimeters.

Example 24 provides the networked electronics system of any one of examples 18-23, where a length of the microwave-absorbing sleeve covering the portion of the cable jacket is between 5 centimeters and 10 centimeters.

Example 25 provides the networked electronics system of any one of examples 18-24, where a thickness of the microwave-absorbing sleeve covering the portion of the cable jacket is equal to or less than 1 centimeter.

Example 26 provides the networked electronics system of any one of examples 18-25, where a loss tangent of the microwave-absorbing sleeve is equal to or less than 1.5.

Example 27 provides the networked electronics system of any one of examples 18-26, where a loss tangent of the microwave-absorbing sleeve is equal to or less than 1.

Example 28 provides the networked electronics system of any one of examples 18-27, where the microwave-absorbing sleeve is formed from a material that includes one or more of: carbon particles and magnetic particles.

Example 29 provides the networked electronics system of any one of examples 18-28, further including one or more further microwave-absorbing material surrounding and covering one or more further portions of the cable jacket respectively.

Example 30 provides the networked electronics system of any one of examples 18-29, where the microwave-absorbing sleeve is attached to the portion of the cable jacket via an adhesive.

Example 31 provides the networked electronics system of any one of examples 18-30, where the microwave-absorbing sleeve is attached to the portion of the cable jacket via surface friction.

Example 32 provides the networked electronics system of any one of examples 18-31, where the first Ethernet physical layer transceiver includes power over coaxial circuitry.

Example 33 provides the networked electronics system of any one of examples 18-31, where the first Ethernet physical layer transceiver includes one or more of: common-mode choke circuitry and common-mode termination circuitry.

Example 34 provides a method for manufacturing a shielded cable assembly with improved electromagnetic compatibility, the method including forming a shielded cable, the shielded cable including one or more insulated conductors, a shield, and a cable jacket; and applying microwave-absorbing material to an outer surface of the shielded cable to cover a subsection of the outer surface of the shielded cable.

Example 35 provides the method of example 34, where: the subsection of the shielded cable covered by the microwave-absorbing material is located a distance from an end of the shielded cable, where the distance is less than 15 centimeters.

Example 36 provides the method of example 34 or 35, further including cutting a sheet of microwave-absorbing material to a rectangular sheet.

Example 37 provides the method of example 36, where the rectangular sheet has a dimension that corresponds to an outer circumference of the shielded cable.

Example 38 provides the method of example 36 or 37, where the rectangular sheet has a further dimension that is between 5 centimeters to 10 centimeters.

Example 39 provides the method of any one of examples 36-38, where the rectangular sheet has a thickness that is equal to or less than 1 centimeter.

Example 40 provides the method of example 34 or 35, further including forming a tubular sleeve from microwave-absorbing material.

Example 41 provides the method of example 40, where the tubular sleeve has a length that is between 5 centimeters to 10 centimeters.

Example 42 provides the method of example 40 or 41, where the tubular sleeve has a thickness that is equal to or less than 1 centimeter.

Example 43 provides the method of any one of examples 40-42, where applying the microwave-absorbing material to the outer surface of the shielded cable includes sliding the microwave-absorbing material onto the subsection of the outer surface of the shielded cable.

Example 44 provides the method of any one of examples 34-43, further including applying an adhesive to the subsection of the outer surface of the shielded cable and/or a surface of the microwave-absorbing material prior to applying the microwave-absorbing material onto the subsection of the outer surface of the shielded cable.

Example 45 provides the method of any one of examples 34-44, further including cutting the shielded cable to length.

Example 46 provides the method of example 45, further including stripping an end of the cut shielded cable.

Example 47 provides the method of example 46, further including attaching cable connectors to a stripped end of the cut shielded cable.

### Variations and Other Notes

The detailed description, such as the “Select examples” section, provide various examples of the embodiments disclosed herein.

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A shielded cable assembly with improved electromagnetic compatibility, the shielded cable assembly comprising:
one or more insulated conductors;
shielding material surrounding the one or more insulated conductors;
a cable jacket layer surrounding the shielding material;
a first end coupled to a first cable connector;
a second end coupled to a second cable connector; and
a first microwave-absorbing material disposed around the cable jacket layer, wherein the first microwave-absorbing material covers a first segment of the cable jacket layer.

2. The shielded cable assembly of claim 1, wherein the first segment of the cable jacket layer covered by the first microwave-absorbing material is adjacent to the first cable connector.

3. The shielded cable assembly of claim 1, wherein the first segment of the cable jacket layer covered by the first microwave-absorbing material is disposed at a distance from the first cable connector.

4. The shielded cable assembly of claim 1, wherein the first segment of the cable jacket layer covered by the first microwave-absorbing material is disposed at a location that is closer to the first end than a mid-length point of the shielded cable assembly.

5. The shielded cable assembly of claim 1, wherein the first segment of the cable jacket layer covered by the first microwave-absorbing material and the first cable connector are separated by a distance that is equal to or less than 15 centimeters from the first cable connector.

6. The shielded cable assembly of claim 1, wherein the first segment of the cable jacket layer covered by the first microwave-absorbing material and the first cable connector are separated by a distance that is equal to or less than 5 centimeters.

7. The shielded cable assembly of claim 1, wherein a length of the first microwave-absorbing material covering the first segment of the cable jacket layer is between 5 centimeters and 10 centimeters.

8. The shielded cable assembly of claim 1, wherein a thickness of the first microwave-absorbing material covering the first segment of the cable jacket layer is equal to or less than 1 centimeter.

9. The shielded cable assembly of claim 1, wherein a loss tangent of the first microwave-absorbing material is equal to or less than 1.5.

10. The shielded cable assembly of claim 1, wherein a loss tangent of the first microwave-absorbing material is equal to or less than 0.5.

11. The shielded cable assembly of claim 1, wherein the first microwave-absorbing material includes one or more of: carbon particles and magnetic particles.

12. The shielded cable assembly of claim 1, wherein the first cable connector is an in-line cable connector.

13. The shielded cable assembly of claim 1, further comprising:
a second microwave-absorbing material disposed around the cable jacket layer and covers a second segment of the cable jacket layer.

14. The shielded cable assembly of claim 1, further comprising:
a third microwave-absorbing material disposed around the cable jacket layer and covers a third segment of the cable jacket layer.

15. A networked electronics system with improved electromagnetic compatibility, the networked electronics system comprising:
a first Ethernet physical layer transceiver;
a second Ethernet physical layer transceiver; and
a shielded cable to communicably couple the first Ethernet physical layer transceiver and the second Ethernet physical layer transceiver, the shielded cable comprising:
one or more insulated conductors;
a shield surrounding the one or more insulated conductors;
a cable jacket surrounding the shield;
a first cable connector attached to a first terminating end of the shielded cable and coupled to the first Ethernet physical layer transceiver;
a second cable connector attached to a second terminating end of the shielded cable and coupled to the second Ethernet physical layer transceiver; and
a microwave-absorbing sleeve surrounding and covering a portion of the cable jacket.

16. The networked electronics system of claim 15, wherein the microwave-absorbing sleeve is attached to the portion of the cable jacket via an adhesive.

17. The networked electronics system of claim 15, wherein the microwave-absorbing sleeve is attached to the portion of the cable jacket via surface friction.

18. A method for manufacturing a shielded cable assembly with improved electromagnetic compatibility, the method comprising:
forming a shielded cable, the shielded cable including one or more insulated conductors, a shield, and a cable jacket; and
applying microwave-absorbing material to an outer surface of the shielded cable to cover a subsection of the outer surface of the shielded cable.

19. The method of claim 18, wherein:
the subsection of the shielded cable covered by the microwave-absorbing material is located a distance from an end of the shielded cable, wherein the distance is less than 15 centimeters.

20. The method of claim 18, further comprising:
cutting a sheet of microwave-absorbing material to a rectangular sheet.
